(19) United States
(12) Patent Application Publication
(10) Pub. No.: US 2004/0131424 A1
(43) Pub. Date: Jul. 8, 2004

(54) Solvent extraction landfill system and method

(76) Inventor: Dan L. Wensel, Phoenix, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 10/337,186

(22) Filed: Jan. 6, 2003

(51) Int. Cl. B09B 1/00; G21F 9/00; B65D 90/24

(52) U.S. Cl. 405/129.2; 405/129.57; 405/129.1

(57) ABSTRACT

A system and method for extracting metals from material deposited in a landfill include applying a leaching solution to the material. The leaching solution dissolves various metals it contacts, forming a leachate bearing one or more metals. The metal-bearing leachate is further processed in a solvent extraction (SX) plant to produce a metal-bearing solution. The metal bearing solution undergoes further processing, such as electrowinning (EW), to recover one or more metals from the metal-bearing solution.

### FIELD OF THE INVENTION

The present invention relates to a metal extraction and, more particularly, to a system and method for extracting metals from material deposited in a landfill.

### BACKGROUND OF THE INVENTION

Trash, garbage and other waste materials are an inevitable part of life. These waste materials are generally bagged and thrown into personal or other centralized waste collection containers, which are subsequently emptied one or more times each week by a municipal collector or a private collection company. The collector may then haul the collected waste material to a landfill that serves as a centralized collection facility for one or more municipalities, or one or more sections of one or more municipalities.

Much of the waste material that is generated and hauled to landfills may be classified as just that, waste. On the other hand, some of the waste material, such as paper, plastics, glass, and metal, may be reused. Thus, many municipalities have initiated recycling programs. Under an exemplary recycling program, recyclable materials may be disposed of separately by, for example, placing recyclable materials into separate waste containers. The collectors then collect the recyclable materials, and dispose of it separately. For example, the material may be separated and processed for resale, or sold to another entity for processing, resale and/or reuse.

A recycling program may present at least two advantages for a municipality. First, the resale of recycled material may provide additional revenue to the municipality. And second, recycling may reduce the amount of waste material stored in the landfill, thus providing long-term cost savings by reducing the need for new landfills. Nonetheless, despite its potential advantages, some municipalities may recover only about 10% of the metals that are discarded as waste material.

While there may be several reasons for a low metal recovery rate, one reason may be that the public is not fully diligent in separating recyclable metals from its other waste. Another reason may be that some of the potentially recyclable metals are not easily separable from other waste. Yet another reason may be that some metallic items such as, for example, paper clips, straight pins, bottle caps, finish nails, and staples, may not be effectively recycled, due to the size and/or content of the items. In some instances metals may not be recycled because of the end-use product in which the metal resides. For example, the metal in twist ties, coated wire, and clothing snaps, zippers, and buttons, are generally not recovered and recycled. Presently, there are no systems and methods in use that can cost-effectively extract the metal material from a landfill that has not already been presorted.

Hence, there is a need for a system and method of extracting metal from a landfill, that is cost effective and/or is able to extract metals that are not easily separable and/or metals that are not easily presorted. The present invention addresses one or more of these needs.

### SUMMARY OF THE INVENTION

The present invention provides a novel and efficient system and method for extracting metals from a landfill.

In one embodiment, and by way of example only, a method of recovering one or more metals from material deposited in a landfill includes applying a leaching solution to material deposited in a landfill to produce a metal-bearing leachate. The metal-bearing leachate is then subjected to at least a solvent extraction (SX) process to produce a solution containing the one or more metals.

In another exemplary embodiment, a system for recovering one or more metals from material deposited in a liner of a landfill includes a supply conduit, at least one flow orifice in each supply conduit, an SX system, and a leachate removal conduit. The supply conduit has at least a first end adapted to couple to a source of a leaching solution and has at least a section thereof positioned above at least a portion of the material deposited in the landfill. Each flow is positioned such that, when leaching solution flows in the conduit, leaching solution is applied to at least a portion of the landfill-deposited material. The SX system is operable to produce at least a solution containing the one or more metals. The leachate removal conduit is fluidly coupled to the liner and the SX system.

Other independent features and advantages of the preferred landfill solvent extraction system and method will become apparent from the following detailed description, taken in conjunction with the accompanying drawings which illustrate, by way of example, the principles of the invention.

### BRIEF DESCRIPTION OF THE DRAWINGS

FIG. 1 is a functional schematic diagram of an exemplary landfill metal extraction system according to one embodiment of the present invention;

FIG. 2 illustrates an exemplary solvent extraction (SX) plant that may be used with the system of FIG. 1; and

FIG. 3 is a simplified diagram of a power plant that may be used with the system of FIG. 1.

### DETAILED DESCRIPTION OF A PREFERRED EMBODIMENT

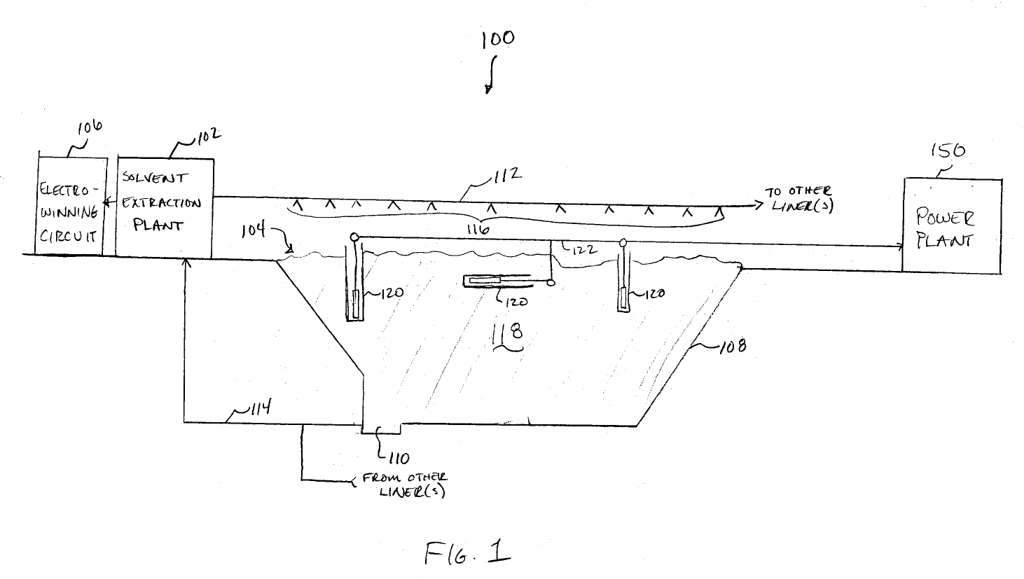

A functional schematic diagram of an exemplary landfill metal extraction system according to one embodiment is illustrated in FIG. 1. As FIG. 1 illustrates, the exemplary system 100 includes at least a solvent extraction (SX) plant 102 fluidly coupled to a landfill 104. As will be described further below, the system 100 may also include an electrowinning (EW) circuit 106.

The landfill 104 may be constructed in any one of numerous configurations using any one of numerous methods. In a preferred embodiment, however, the landfill 104 is constructed to include a liner 108. The liner 108 inhibits any fluid that may be present in the landfill 104 from penetrating into the ground, and potentially reaching and contaminating the water table. The bottom of the liner 108 is preferably sloped toward a sump region 110. Thus, any fluid in the landfill 104 will eventually drain to the sump region 110.

The SX plant 102 is fluidly coupled to the landfill 104 via one or more leaching solution supply conduits 112, and one or more leachate removal conduits 114. The SX plant 102, as will be described more fully below, includes a supply of a leaching solution. The leaching solution is preferably an acid solution that dissolves any metal it comes in contact with into solution, thereby producing a metal-bearing leachate. The leaching solution may be any one of numerous weak acid solutions such as, for example, a weak sulfuric acid solution. As FIG. 1 further illustrates, the SX plant 102 can service more than one liner 108, if the landfill 104 is configured with a plurality of liners 108.

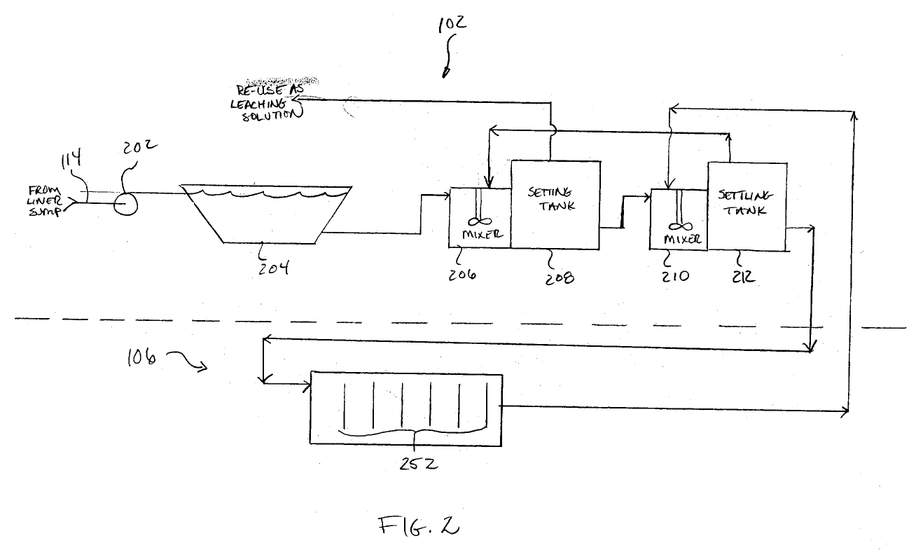

One or more flow orifices 116 is formed in the leaching solution supply conduit 112. The flow orifices 16 may be constructed in any one of numerous configurations including, but not limited to, simple openings formed directly in the solution supply conduit 112, spray nozzles coupled to the supply conduit 112, or drip lines coupled to the supply conduit. The flow orifices 116 are positioned and configured to apply leaching solution onto waste material 118 that is deposited in the landfill 104. As was noted above, as the leaching solution flows through the waste material 118, it dissolves various metals it comes into contact with into solution and flows, as a metal-bearing leachate, into the liner sump region 110. The metal-bearing leachate that collects in the liner sump region 110 is supplied back to the SX plant 102, via the removal conduits 114. In the SX plant 102, the metal-bearing leachate undergoes a process that produces, among other things, a solution bearing one or more metals. With reference to FIG. 2, an exemplary system and process carried out in the SX plant 102 to produce this metal-bearing solution will now be described.

As FIG. 2 illustrates, the metal-bearing leachate in the liner sump region 110 is transferred to the SX plant 102 by, for example, a pump 202. In the SX plant 102, the metal-bearing leachate may be collected in a pond 204, and then transferred to a first mixer 206. In the first mixer 206, the metal-bearing leachate is mixed with one or more organic extractants, which extract one or more of the metals from the metal-bearing leachate, and produce one or more metal-free acid phases and one or more organic metal-containing phases. The metal-free acid phases and organic metal-containing phases are then separated in a first settling tank 208.

From the first settling tank 208, the metal-free acid phases may be transferred for reuse as the leaching solution, and the organic metal-containing phases are transferred to a second mixer 210. In the second mixer 210, the organic metal-containing phases are mixed with one or more strongly acidic electrolyte solutions, such as sulphuric acid, which strip the metals from the organic phases and produce one or more metal-bearing aqueous solutions. The stripped organics and the metal-bearing aqueous solutions are then separated in a second settling tank 212. The stripped organics are then transferred for reuse in the first mixer 206 as extractants, and the metal-bearing aqueous solutions are transferred for further processing to recover the metals from the aqueous solution.

Various processes may be used to recover the metals from the metal-bearing aqueous solution. However, in a preferred embodiment, the metal-bearing aqueous solution is transferred to an electrowinning (EW) plant 106, where it subjected to an EW process. As is generally known, during the EW process, the metal-bearing aqueous solution is circulated through and between electrically charged plates 252. As the solution circulates through the plates 252, electrolysis causes the metals to plate out onto various ones of the charged plates 252. The plates 252 are periodically removed and the substantially pure metals plated out on them may be harvested. The electrolyte solution used in the EW plant 106 may be recirculated back to the second mixer 210 for use as the strongly acidic electrolyte solution that strips the metals from the organic phases.

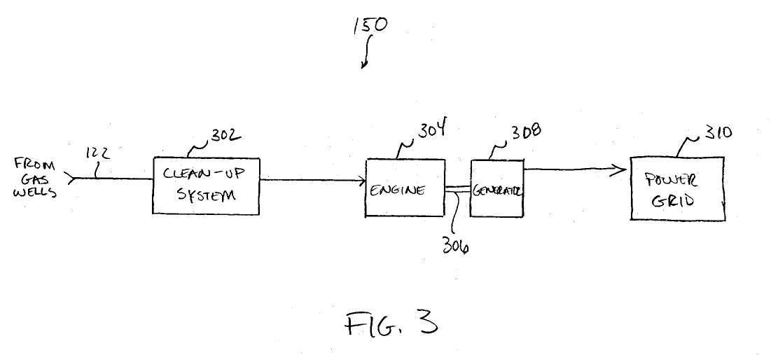

In addition to recovering metals from the landfill-deposited waste material 118, it is noted that as the leaching solution leaches through the waste material 118 the production of methane and other flammable gases is accelerated. Thus, power production is also a benefit that can be derived. As FIG. 1 illustrates, a plurality of gas wells 120, which may be arranged vertically, horizontally, or both, extract the gases from the waste material 118. One or more conduits 122 transfer the extracted gases to a power plant 150, which is depicted in simplified form in FIG. 3.

In the power plant 150, the gases may be passed through a clean-up system 302 that removes moisture and particulate from the gas stream. The clean gases are then piped to an internal combustion type engine 304. Combustion of the gases in the engine 304 turns a shaft 306 that is coupled to a generator 308, which supplies electrical power. The generated electrical power may be transferred onto the local power grid 310 and/or reused at the local site.

The solvent extraction landfill system and method described herein allows one or more metals to be extracted from landfill-deposited waste material that would otherwise remain in the landfill. The system and method reduces the volume of remaining waste material, thus increasing the available landfill storage. The system and method also accelerates the production of flammable gases from the landfill. These gases may be combusted and used to generate electrical energy.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

I claim:

1. A method of recovering one or more metals from material deposited in a landfill, the method comprising:
applying a leaching solution to material deposited in a landfill to produce a metal-bearing leachate therefrom; and
subjecting the metal-bearing leachate to at least a solvent extraction (SX) process to produce a solution containing the one or more metals.

2. The method of claim 1, further comprising:
subjecting the solution to an electrowinning (EW) process to recover the one or metals therefrom.

3. The method of claim 1, further comprising:
contacting the metal-bearing leachate with an organic extractant to extract the one or more metals therefrom and produce a metal-free acid phase and an organic metal-containing phase.

4. The method of claim 3, further comprising:
using the metal-free acid phase as at least a portion of the leaching solution that is applied to the material deposited in the landfill.

5. The method of claim 3, further comprising:
contacting the organic-metal containing phase with an acidic solution to produce metal-bearing aqueous solution.

6. The method of claim 5, further comprising:
subjecting the metal-bearing aqueous solution to an electrowinning (EW) process to recover the one or more metals therefrom.

7. The method of claim 1, further comprising:
extracting gas from at least a portion of the landfill.

8. The method of claim 7, further comprising:
burning at least a portion of the extracted gas.

9. The method of claim 7, further comprising:
burning at least a portion of the extracted gas in a gas-powered electrical generator to produce electrical energy.

10. The method of claim 1, wherein the leaching solution is substantially acidic.

11. A system for recovering one or more metals from material deposited in a liner of a landfill, comprising:
a supply conduit having at least a first end adapted to couple to a source of a leaching solution and having at least a section thereof positioned above at least a portion of the material deposited in the landfill;
at least one flow orifice in each conduit, each flow orifice positioned such that, when leaching solution flows in the conduit, leaching solution is applied to at least a portion of the landfill-deposited material;
a solvent extraction (SX) system operable to produce at least a solution containing the one or more metals; and
at least one leachate removal conduit fluidly coupled between the liner and the SX system.

12. The system of claim 11, further comprising:
an electrowinning (EW) system fluidly coupled to the SX system.

13. The system of claim 11, further comprising:
a feedback conduit in fluid communication between the SX system and the supply conduit.

13. The system of claim 11, further comprising:
a leachate collection sump in fluid communication with the leachate removal conduit and the liner.

14. The system of claim 11, further comprising:
a gas extraction well operable to extract gas from at least a portion of the landfill.

15. The system of claim 14, further comprising:
a gas burner fluidly coupled to receive extracted gas from the gas extraction well.

16. The system of claim 15, wherein the gas burner includes a gas-powered electrical generator to produce electrical energy.
